(19) United States
(12) Patent Application Publication
(10) Pub. No.: US 2014/0294394 A1
(43) Pub. Date: Oct. 2, 2014

(54) OPTICAL COMMUNICATION APPARATUS AND OPTICAL COMMUNICATION METHOD

(71) Applicant: Electronics and Telecommunications Research Institute, Daejeon (KR)

(72) Inventors: Hyun Jae LEE, Daejeon (KR); Bheom Soon JOO, Daejeon (KR)

(73) Assignee: Electronics and Telecommunications Research Institute, Daejeon (KR)

(21) Appl. No.: 14/080,349

(22) Filed: Nov. 14, 2013

(30) Foreign Application Priority Data
Apr. 1, 2013 (KR) 10-2013-0035422

(51) Int. Cl. H04J 14/02

(52) U.S. Cl. CPC H04J 14/021
USPC 398/83

(57) ABSTRACT

An optical communication apparatus and an optical communication method are disclosed. An optical communication apparatus mounted in a first node in a linear network coupled among a plurality nodes through an optical transmission line includes a multiplexer for receiving a plurality of optical signals having different wavelengths to output a first multi-wavelength optical signal obtained by coupling the plurality of optical signals, and a first optical coupler for dividing the first multi-wavelength optical signal into respective multi-wavelength optical signals to be transmitted to at least two different neighboring nodes.

### CROSS-REFERENCE TO RELATED APPLICATION

This application claims priority to and the benefit of Korean Patent Application No. 10-2013-0035422 filed in the Korean Intellectual Property Office on Apr. 1, 2013, the entire contents of which are incorporated herein by reference.

### BACKGROUND OF THE INVENTION

(a) Field of the Invention

The present invention relates to an optical communication apparatus and an optical communication method.

(b) Description of the Related Art

In a conventional linear network, a signal is dropped and inserted to be separated, and is processed by a receiver. Then, a necessary signal is retransmitted using a transmitter. However, in such a signal processing method, a signal is processed for each channel using a receiver and a transmitter.

In conventional re-configurable optical add-drop multiplexing (ROADM) equipment, an optical signal that is not divided and coupled by a node is not converted into an electrical signal but is transmitted in the form of the optical signal as it is. Then, photoelectric conversion and electro-optic conversion are performed only on a signal to be divided and coupled, and the signal is transmitted.

As described above, in a conventional art, after each node drops a signal and performs electro-optic conversion on the signal, the signal must be retransmitted. That is, a bi-directional transmission method is not suggested.

### SUMMARY OF THE INVENTION

An object of the present invention is to provide an optical communication apparatus and an optical communication method for bi-directionally multicasting a multi-wavelength optical signal in a linear network.

According to an exemplary embodiment of the present invention, an optical communication apparatus mounted in a first node in a linear network coupled among a plurality nodes through an optical transmission line includes a multiplexer for receiving a plurality of optical signals having different wavelengths to output a first multi-wavelength optical signal obtained by coupling the plurality of optical signals, and a first optical coupler for dividing the first multi-wavelength optical signal into respective multi-wavelength optical signals to be transmitted to at least two different neighboring nodes.

The optical communication apparatus may further include a second optical coupler for coupling the first multi-wavelength optical signal output by the first optical coupler and a second multi-wavelength optical signal received from a first neighboring node to transmit a coupled multi-wavelength optical signal to a second neighboring node, and a third optical coupler for coupling the first multi-wavelength optical signal output by the first optical coupler and a third multi-wavelength optical signal received from the second neighboring node to transmit a coupled multi-wavelength optical signal to the first neighboring node.

The optical communication apparatus may further include a third optical coupler for receiving a plurality of multi-wavelength optical signals from a plurality of different neighboring nodes to output a coupled multi-wavelength optical signal.

The optical communication apparatus may further includes a demultiplexer for outputting the multi-wavelength optical signal output by the third optical coupler as the plurality of multi-wavelength optical signals.

The optical communication apparatus may further include a plurality of demultiplexers for dividing the respective multi-wavelength optical signals output by the demultiplexer by wavelengths to output divided multi-wavelength optical signals.

The optical communication apparatus may further includes a first drop and continue module for dividing the second multi-wavelength optical signal by entire signals, by channels, or by bands to output divided multi-wavelength optical signals to the second optical coupler. The first drop and continue module may include a band-pass filter for passing an optical signal of a specific band, and a band-reject filter for stopping only an optical signal of a specific band.

The optical communication apparatus may further include a first optical amplifier for amplifying the second multi-wavelength optical signal to output an amplified multi-wavelength optical signal to the first drop and continue module, and a second optical amplifier for amplifying a multi-wavelength optical signal to be transmitted to the second neighboring node and output by the second optical coupler.

The optical communication apparatus may further include a second drop and continue module for dividing the third multi-wavelength optical signal by entire signals, by channels, or by bands to output divided multi-wavelength optical signals to the third optical coupler.

The optical communication apparatus may further include a third optical amplifier for amplifying the third multi-wavelength optical signal to output an amplified multi-wavelength optical signal to the third drop and continue module, and a fourth optical amplifier for amplifying a multi-wavelength optical signal to be transmitted to the first neighboring node and output by the third optical coupler.

According to another exemplary embodiment of the present invention, an optical communication method includes a first node that belongs to a linear network coupled among a plurality of nodes through an optical transmission line receiving a plurality of optical signals having different wavelengths, outputting a first multi-wavelength optical signal obtained by coupling the plurality of optical signals, dividing the first multi-wavelength optical signal into at least two multi-wavelength optical signals, and transmitting the at least two multi-wavelength optical signals to different neighboring nodes.

Transmitting the at least two multi-wavelength optical signals to different neighboring nodes may include receiving a second multi-wavelength optical signal from a first neighboring node, and coupling the first multi-wavelength optical signal and the second multi-wavelength optical signal to transmit a coupled multi-wavelength optical signal to a second neighboring node.

Transmitting a coupled multi-wavelength optical signal to the second neighboring node may include dividing the second multi-wavelength optical signal by entire signals, by channels, or by bands, and coupling the divided second multi-wavelength optical signal to the first multi-wavelength optical signal to transmit a coupled multi-wavelength optical signal to the second neighboring node.

Transmitting a coupled multi-wavelength optical signal to the second neighboring node may further include receiving a third multi-wavelength optical signal from a second neighboring node, and coupling the first multi-wavelength optical signal and the third multi-wavelength optical signal to transmit a coupled multi-wavelength optical signal to the first neighboring node.

Transmitting a coupled multi-wavelength optical signal to the first neighboring node may include dividing the third multi-wavelength optical signal by entire signals, by channels, or by bands, and coupling a divided third multi-wavelength optical signal and the first multi-wavelength optical signal to transmit a coupled multi-wavelength optical signal to the first neighboring node.

After transmitting the at least two multi-wavelength optical signals to the different neighboring nodes, the optical communication method may further include receiving a plurality of multi-wavelength optical signals received from a plurality of neighboring nodes, coupling a plurality of received multi-wavelength optical signals, dividing a plurality of coupled multi-wavelength optical signals into a plurality of multi-wavelength optical signals to output the plurality of multi-wavelength optical signals, and dividing a plurality of divided multi-wavelength optical signals by wavelengths to output divided multi-wavelength optical signals.

According to the exemplary embodiment of the present invention, since a drop node drops an entire signal transmitted by another node and performs photoelectric conversion on the dropped entire optical signal, and when a signal is inserted, electro-optic conversion is performed only on a newly coupled signal to insert an optical signal and the remaining signal is passed without performing electro-optic conversion, it is possible to realize an optical signal multicasting system with a simple structure. Therefore, the optical signal multicasting system may be useful in providing broadcasting services by areas.

In addition, since optical signal multicasting may be efficiently performed in a linear optical network, it is possible to reduce capital expenditures (CAPEX) and operating expenditure (OPEX), to economically form a network, and to simply realize a linear optical network to which a multicasting method is applied.

### BRIEF DESCRIPTION OF THE DRAWINGS

FIG. 1 is a linear optical network schematic diagram according to an exemplary embodiment of the present invention.

FIG. 2 is a flowchart illustrating an optical communication method according to an exemplary embodiment of the present invention.

FIG. 3 is a flowchart illustrating an optical communication method according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, a mobile station (MS) may refer to a terminal, a mobile terminal (MT), a subscriber station (SS), a portable subscriber station (PSS), an access terminal (AT), user equipment (UE), and a high reliability mobile station (HR-MS), and may include functions of all or some of the terminal, the MT, the SS, the PSS, the AT, and the UE.

In addition, a base station (BS) may refer to a node B, an evolved node B (eNodeB), an access point (AP), a radio access station (RAS), a base transceiver station (BTS), a mobile multihop relay (MMR)-BS, and a high reliability base station (HR-BS), and may include functions of all or some of the node B, the eNodeB, the AP, the RAS, the BTS, and the MMR-BS. Hereinafter, an optical communication apparatus and an optical communication method will be described with reference to the drawings.

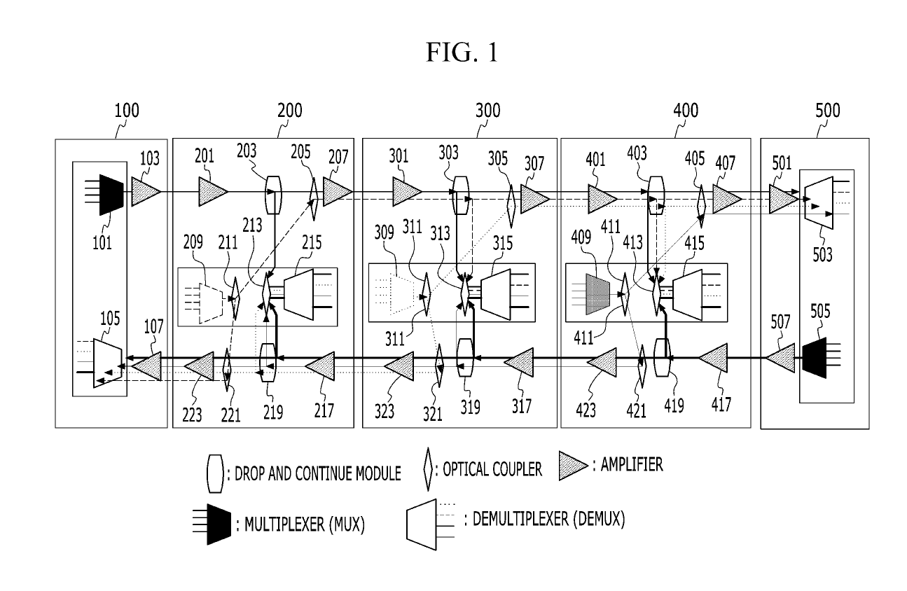

FIG. 1 is a linear optical network schematic diagram according to an exemplary embodiment of the present invention.

Referring to FIG. 1, a linear network multicasts a multi-wavelength optical signal. Here, multicasting is a method of transmitting information from one input node to a number of destination nodes.

At this time, unlike in a conventional art, in a linear network, input and output may be performed by all nodes 100, 200, 300, 400, and 500 so that bi-directional multicasting may be performed. According to the exemplary embodiment of the present invention, for convenience sake, it is defined that three forwarding nodes 200, 300, and 400 are included between two input and output nodes 100 and 500. Here, the number of forwarding nodes is not limited to three, but at least one transmission node may be included.

The input and output nodes 100 and 500 input and output a multi-wavelength optical signal. The forwarding nodes 200, 300, and 400 input, output, and transmit the multi-wavelength optical signal. The forwarding nodes 200, 300, and 400 bi-directionally transmit the multi-wavelength optical signal.

The multi-wavelength optical signal is transmitted and received between the first input node 100 and the first transmission node 200, between the second transmission node 300 and the third transmission node 400, and between the third transmission node 400 and the second input node 500 through an optical transmission line (not shown).

Structures of the respective nodes will be described in detail as follows.

The first input node 100 includes an optical transmitter, a multiplexer (MUX) 101, and an optical amplifier1 103 as input units, and includes an optical amplifier2 107, a demultiplexer (DEMUX) 105, and an optical receiver as output units.

The multiplexer 101 receives a number of signals having different wavelengths to output a multi-wavelength optical signal. The optical amplifier1 103 amplifies the multi-wavelength optical signal output by the multiplexer 101. As described above, the amplified multi-wavelength optical signal is transmitted to the first transmission node 200 through an optical transmission line (not shown).

The demultiplexer 105 divides a plurality of multi-wavelength optical signals amplified and output by the optical amplifier2 107 and received from the first transmission node 200 in accordance with wavelengths to output divided multi-wavelength optical signals to different channels. In the first transmission node 200, an optical amplifier1 201, a drop and continue module1 203, an optical coupler1 205, and an optical amplifier2 207 are used for performing transmission from the first transmission node 200 to the second transmission node 300. The drop and continue module1 203, the optical coupler3 213, and a demultiplexer 215 are used for performing output. In addition, an optical transmitter multiplexer 209, an optical coupler2 211, and the optical coupler1 205 are used for performing input.

An optical amplifier3 217, a drop and continue module2 219, an optical coupler4 221, and an amplifier4 223 are used for performing transmission from the first transmission node 200 to the input node 100. The drop and continue module2 219, an optical coupler3 213, and the demultiplexer 215 are used for performing output. In addition, an optical transmitter multiplexer 209, an optical coupler2 211, and an optical coupler4 221 are used for performing input.

The optical amplifier1 201 amplifies a multi-wavelength optical signal transmitted by the first input node 100 to output the amplified multi-wavelength optical signal. The drop and continue module1 203 divides the multi-wavelength optical signal output by the optical amplifier1 201 by entire signals, by channels, and by bands as occasion demands to drop and pass divided multi-wavelength optical signals. The optical coupler1 205 couples the multi-wavelength optical signal passed by the drop and continue module1 203 and a multi-wavelength optical signal divided by the optical coupler2 211 to output a coupled multi-wavelength optical signal. The optical amplifier2 207 amplifies the multi-wavelength optical signal coupled and output by the optical coupler1 205. As described above, the amplified multi-wavelength optical signal is transmitted to the second transmission node 300 through an optical transmission line (not shown).

The multiplexer 209 receives a number of wavelengths to output a multi-wavelength optical signal. The optical coupler2 211 divides the multi-wavelength optical signal output by the multiplexer 209 to output divided multi-wavelength optical signals to two different optical couplers, that is, the optical coupler1 205 and the optical coupler4 221. The optical coupler3 213 couples the multi-wavelength optical signal dropped by the drop and continue module1 203 and a multi-wavelength optical signal dropped by the drop and continue module2 219, respectively, to output a coupled multi-wavelength optical signal. The demultiplexer 215 divides the multi-wavelength optical signal output by the optical coupler3 213 in accordance with wavelengths, and outputs divided multi-wavelength optical signals to different channels. A demultiplexer (not shown) may be added to the demultiplexer 215 as occasion demands. The added demultiplexer (not shown) receives the multi-wavelength optical signals output by the demultiplexer 215, and divides the multi-wavelength optical signals in accordance with wavelengths to output divided multi-wavelength optical signals to different channels.

The optical amplifier3 217 receives at least one multi-wavelength optical signal from the second transmission node 300 to amplify the received multi-wavelength optical signal. The drop and continue module2 219 divides the at least one multi-wavelength optical signal amplified by the optical amplifier3 217 by entire signals, by channels, and by bands to drop and pass divided multi-wavelength optical signals. The optical coupler4 221 couples the at least one multi-wavelength optical signal continued by the drop and continue module2 219 and the multi-wavelength optical signal output by the optical coupler2 211. The optical amplifier 223 amplifies the multi-wavelength optical signal coupled and output by the optical coupler4 221. The amplified multi-wavelength optical signal is transmitted to the first input node 100. The second transmission node 300 includes an optical amplifier1 301, a drop and continue module1 303, an optical coupler1 305, an optical amplifier2 307, a multiplexer 309, an optical coupler2 311, an optical coupler3 313, a demultiplexer 315, an optical amplifier3 317, a drop and continue module2 319, an optical coupler4 321, and an optical amplifier4 323. The optical amplifier1 301 receives at least one multi-wavelength optical signal received from the first transmission node 200, and amplifies the received multi-wavelength optical signal to output the amplified multi-wavelength optical signal. The at least one multi-wavelength optical signal includes the multi-wavelength optical signal transmitted by the first input node 100 and the multi-wavelength optical signal generated by the first transmission node 200.

The drop and continue module1 303 divides the multi-wavelength optical signal output by the optical amplifier1 301 by entire signals, by channels, and by bands to drop and pass divided multi-wavelength optical signals. The optical coupler1 305 couples the multi-wavelength optical signal passed by the drop and continue module1 303 and a multi-wavelength optical signal divided by the optical coupler2 311 to output a coupled multi-wavelength optical signal. The optical amplifier2 307 amplifies the multi-wavelength optical signal coupled by the optical coupler1 305. As described above, the amplified multi-wavelength optical signal is transmitted to the third transmission node 400 through an optical transmission line (not shown).

The multiplexer 309 receives a number of wavelengths to output a multi-wavelength optical signal. The optical coupler2 311 divides the multi-wavelength optical signal output by the multiplexer 309 to output divided multi-wavelength optical signals to two different optical couplers, that is, the optical coupler1 305 and the optical coupler4 321. The optical coupler3 313 couples the multi-wavelength optical signal dropped by the drop and continue module1 303 and a multi-wavelength optical signal dropped by the drop and continue module2 319, respectively, to output a coupled multi-wavelength optical signal. The demultiplexer 315 divides the multi-wavelength optical signal output by the optical coupler3 313 in accordance with wavelengths, and outputs divided multi-wavelength optical signals to different channels. At this time, a demultiplexer (not shown) may be added to the demultiplexer 315 as occasion demands. The added demultiplexer (not shown) receives the multi-wavelength optical signals output by the demultiplexer 315, and divides the multi-wavelength optical signals in accordance with wavelengths to output divided multi-wavelength optical signals to different channels.

The optical amplifier3 317 receives at least one multi-wavelength optical signal from the third transmission node 400 to amplify the received multi-wavelength optical signal. The drop and continue module2 319 divides the at least one multi-wavelength optical signal amplified by the optical amplifier3 317 by entire signals, by channels, and by bands to drop and pass divided multi-wavelength optical signals. The optical coupler4 321 couples the at least one multi-wavelength optical signal continued by the drop and continue module2 319 and the multi-wavelength optical signal output by the optical coupler2 311. The optical amplifier 323 amplifies the multi-wavelength optical signal coupled by the optical coupler4 321. The amplified multi-wavelength optical signal is transmitted to the first transmission node 200.

The third transmission node 400 includes an optical amplifier1 401, a drop and continue module1 403, an optical coupler1 405, an optical amplifier2 407, a multiplexer 409, an optical coupler2 411, an optical coupler3 413, a demultiplexer 415, an optical amplifier3 417, a drop and continue module2 419, an optical coupler4 421, and an optical amplifier4 423.

The optical amplifier1 401 receives at least one multi-wavelength optical signal from the second transmission node 300 and amplifies the received multi-wavelength optical signal to output the amplified multi-wavelength optical signal. The at least one multi-wavelength optical signal includes the multi-wavelength optical signal transmitted by the first input node 100, the multi-wavelength optical signal transmitted by the first transmission node 200, and the multi-wavelength optical signal generated by the second transmission node 300.

The drop and continue module1 403 divides the multi-wavelength optical signal output by the optical amplifier1 401 by entire signals, by channels, and by bands to drop and pass divided multi-wavelength optical signals. The optical coupler1 405 couples the multi-wavelength optical signal passed by the drop and continue module1 403 and a multi-wavelength optical signal divided by the optical coupler2 411 to output a coupled multi-wavelength optical signal. The optical amplifier2 407 amplifies the multi-wavelength optical signal coupled by the optical coupler1 405. As described above, the amplified multi-wavelength optical signal is transmitted to the second input node 500 through an optical transmission line (not shown).

The multiplexer 409 receives a number of wavelengths to output a multi-wavelength optical signal. The optical coupler2 411 divides the multi-wavelength optical signal output by the multiplexer 409 to output divided multi-wavelength optical signals to two different optical couplers, that is, the optical coupler1 405 and the optical coupler4 421. The optical coupler3 413 couples the multi-wavelength optical signal dropped by the drop and continue module1 403 and a multi-wavelength optical signal dropped by the drop and continue module2 419, respectively, to output a coupled multi-wavelength optical signal. The demultiplexer 415 divides the multi-wavelength optical signal output by the optical coupler3 413 in accordance with wavelengths, and outputs divided multi-wavelength optical signals to different channels. A demultiplexer (not shown) may be added to the demultiplexer 415 as occasion demands. The added demultiplexer (not shown) receives the multi-wavelength optical signals output by the demultiplexer 415, and divides the multi-wavelength optical signals in accordance with wavelengths to output divided multi-wavelength optical signals to different channels.

The optical amplifier3 417 receives at least one multi-wavelength optical signal from the second input node 500 to amplify the received multi-wavelength optical signal. The drop and continue module2 419 divides the at least one multi-wavelength optical signal amplified by the optical amplifier3 417 by entire signals, by channels, and by bands to drop and pass divided multi-wavelength optical signals. The optical coupler4 421 couples the at least one multi-wavelength optical signal passed by the drop and continue module2 419 and the multi-wavelength optical signal output by the optical coupler2 411. The optical amplifier 423 amplifies the multi-wavelength optical signal coupled by the optical coupler4 421. The amplified multi-wavelength optical signal is transmitted to the second transmission node 300.

The second input node 500 includes an optical amplifier1 501, a demultiplexer 503, a multiplexer 505, and an optical amplifier2 507.

The demultiplexer 503 divides a plurality of multi-wavelength optical signals amplified and output by the optical amplifier1 501 and received from the third transmission node 400 in accordance with wavelengths to output divided multi-wavelength optical signals to different channels. The multiplexer 505 receives a number of optical signals having different wavelengths to output a multi-wavelength optical signal. The optical amplifier2 507 amplifies the multi-wavelength optical signal output by the multiplexer 505. As described above, the amplified multi-wavelength optical signal is transmitted to the third transmission node 400 through an optical transmission line (not shown).

As described above, the forwarding nodes 200, 300, and 400 may bi-directionally multicast an optical signal. An optical communication apparatus including the four optical amplifiers (of 201, 207, 217, and 223, 301, 307, 317, and 323, and 401, 407, 417, and 423), the two drop and continue modules (of 203 and 219, 303 and 319, and 403 and 419), the four optical couplers (of 205, 211, 213, and 221, 305, 311, 313, and 321, and 405, 411, 413, and 421), the multiplexers (of 209, 309, and 409), and the at least one demultiplexer (of 215, 315, and 415) is commonly mounted in the forwarding nodes 200, 300, and 400.

The optical communication apparatus mounted in the forwarding nodes 200, 300, and 400 drops and passes the multi-wavelength optical signals received from the other neighboring nodes using the drop and continue modules 203 and 219, 303 and 319, and 403 and 419, respectively. At this time, the multi-wavelength optical signals are divided by entire signals, by bands, and by channels.

Here, when the multi-wavelength optical signals are divided by bands, the drop and continue modules 203, 219, 303, 319, 403, and 419 may pass only an optical signal of a specific band using a band-pass filter. Only an optical signal of a specific band may be dropped using a band-reject filter. As described above, the multi-wavelength optical signal passed by the drop and continue modules 203, 219, 303, 319, 403, and 419 is transmitted to the neighboring nodes.

In addition, when an optical communication apparatus inserts the multi-wavelength optical signal, the multiplexers 209, 309, and 409 capable of coupling a number of channels to transmit a coupled channel to optical fiber and the four optical couplers (of 205, 211, 213, and 221, 305, 311, 313, and 321, and 405, 411, 413, and 421) are used. The four optical amplifiers (of 201, 207, 217, and 223, 301, 307, 317, and 323, and 401, 407, 417, and 423) are useful to compensating for an optical signal reduced when optical signal channels are dropped, passed, and coupled or a signal reduced during long distance transmission. The above method may be useful for optical broadcasting of a signal.

When a linear network is realized in the above structure, an optical channel may be efficiently operated. When the suggested multicasting method is applied, signals transmitted by all of the other nodes may be dropped and processed through the drop and continue modules 203, 219, 303, 319, 403, and 419. That is, various multi-wavelength optical signals received from the respective nodes may be divided by channels, by bands, and by entire signals to be dropped. In addition, various multi-wavelength optical signals desired to be transmitted to neighboring nodes may be transmitted to another neighboring node by channels, by bands, and by entire signals using an optical coupler.

An operation of the optical communication apparatus mounted in the forwarding nodes 200, 300, and 400 will be described as follows.

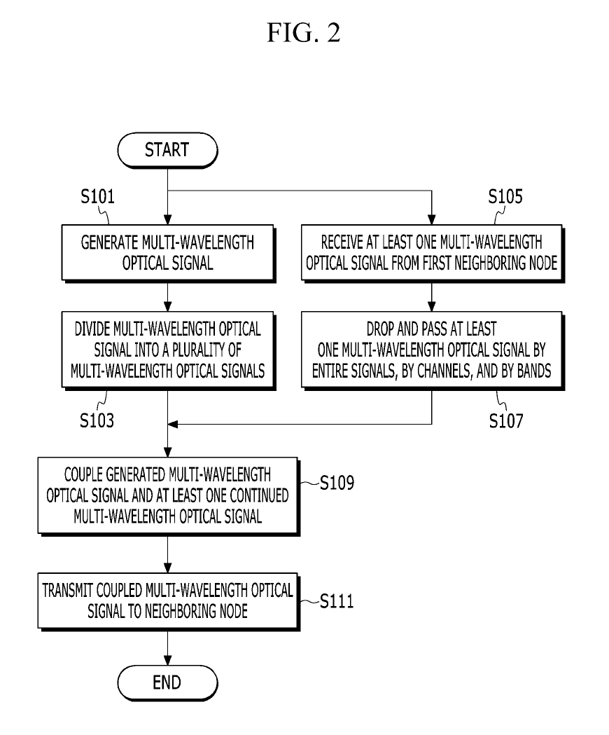

FIG. 2 is a flowchart illustrating an optical communication method according to an exemplary embodiment of the present invention.

Referring to FIG. 2, the arbitrary forwarding nodes 200, 300, and 400 generate multi-wavelength optical signals (S101). The generated multi-wavelength optical signals are coupled by the multiplexers 209, 309, and 409 and are divided into multi-wavelength optical signals by the optical couplers2 211, 311, and 411 (S103).

On the other hand, the arbitrary forwarding nodes 200, 300, and 400 receive at least one multi-wavelength optical signal from a first neighboring node (S105). As described above, the at least one received multi-wavelength optical signal is dropped and passed by the drop and continue modules 203, 219, 303, 319, 403, and 419 (S107).

The optical couplers 205, 305, 405, 221, 321, and 421 of the arbitrary forwarding nodes 200, 300, and 400 couple the multi-wavelength optical signals divided in S103 and the multi-wavelength optical signal passed in S107 (S109). The multi-wavelength optical signal coupled in S109 is transmitted to the first neighboring node and another second neighboring node (S111).

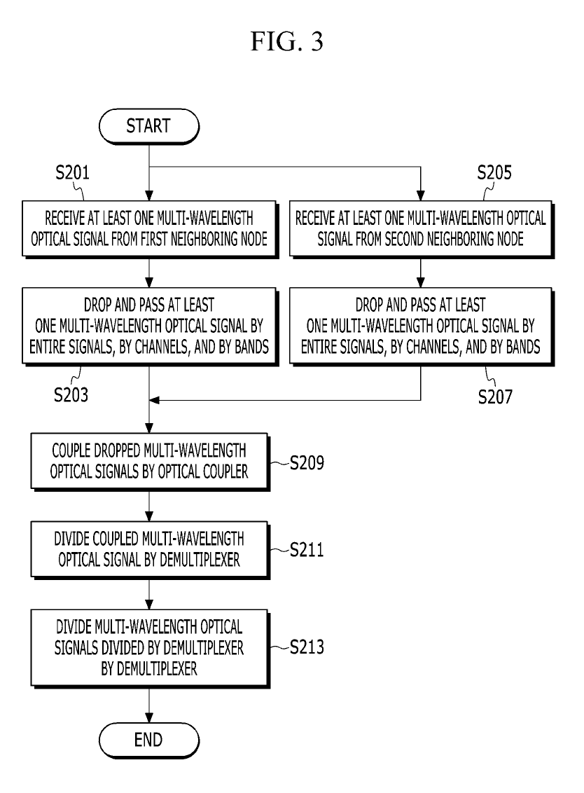

FIG. 3 is a flowchart illustrating an optical communication method according to another exemplary embodiment of the present invention.

Referring to FIG. 3, the arbitrary forwarding nodes 200, 300, and 400 receive at least one multi-wavelength optical signal from the first neighboring node (S201). As described above, the at least one received multi-wavelength optical signal is dropped and passed by the drop and continue modules 203, 219, 303, 319, 403, and 419 (S203).

In addition, the arbitrary forwarding nodes 200, 300, and 400 receive at least one multi-wavelength optical signal from the second neighboring node (S205). As described above, the at least one received multi-wavelength optical signal is dropped and passed by the drop and continue modules 203, 219, 303, 319, 403, and 419 (S207).

The at least one multi-wavelength optical signal dropped in S203 and S207 is coupled by the optical couplers 213, 313, and 413 (S209). A coupled multi-wavelength optical signal is divided by the demultiplexers 215, 315, and 415 by wavelengths (S211).

At this time, the respective multi-wavelength optical signals divided by the demultiplexers 215, 315, and 415 are divided by a plurality of demultiplexers (not shown) by wavelengths as occasion demands (S213).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An optical communication apparatus mounted in a first node in a linear network coupled among a plurality nodes through an optical transmission line, comprising:
a multiplexer for receiving a plurality of optical signals having different wavelengths to output a first multi-wavelength optical signal obtained by coupling the plurality of optical signals; and
a first optical coupler for dividing the first multi-wavelength optical signal into respective multi-wavelength optical signals to be transmitted to at least two different neighboring nodes.

2. The optical communication apparatus of claim 2, further comprising:
a second optical coupler for coupling the first multi-wavelength optical signal output by the first optical coupler and a second multi-wavelength optical signal received from a first neighboring node to transmit a coupled multi-wavelength optical signal to a second neighboring node; and
a third optical coupler for coupling the first multi-wavelength optical signal output by the first optical coupler and a third multi-wavelength optical signal received from the second neighboring node to transmit a coupled multi-wavelength optical signal to the first neighboring node.

3. The optical communication apparatus of claim 2, further comprising a third optical coupler for receiving a plurality of multi-wavelength optical signals from a plurality of different neighboring nodes to output a coupled multi-wavelength optical signal.

4. The optical communication apparatus of claim 3, further comprising a demultiplexer for outputting the multi-wavelength optical signal output by the third optical coupler as the plurality of multi-wavelength optical signals.

5. The optical communication apparatus of claim 4, further comprising a plurality of demultiplexers for dividing the respective multi-wavelength optical signals output by the demultiplexer by wavelengths to output divided multi-wavelength optical signals.

6. The optical communication apparatus of claim 3, further comprising a first drop and continue module for dividing the second multi-wavelength optical signal by entire signals, by channels, or by bands to output divided multi-wavelength optical signals to the second optical coupler.

7. The optical communication apparatus of claim 6, wherein the first drop and continue module comprises a band-pass filter for passing an optical signal of a specific band and a band-reject filter for stopping only an optical signal of a specific band.

8. The optical communication apparatus of claim 6, further comprising:
a first optical amplifier for amplifying the second multi-wavelength optical signal to output an amplified multi-wavelength optical signal to the first drop and continue module; and
a second optical amplifier for amplifying a multi-wavelength optical signal to be transmitted to the second neighboring node and output by the second optical coupler.

9. The optical communication apparatus of claim 3, further comprising a second drop and continue module for dividing the third multi-wavelength optical signal by entire signals, by channels, or by bands to output divided multi-wavelength optical signals to the third optical coupler.

10. The optical communication apparatus of claim 9, further comprising:
a third optical amplifier for amplifying the third multi-wavelength optical signal to output an amplified multi-wavelength optical signal to the third drop and continue module; and
a fourth optical amplifier for amplifying a multi-wavelength optical signal to be transmitted to the first neighboring node and output by the third optical coupler.

11. An optical communication method, comprising:
a first node that belongs to a linear network coupled among a plurality of nodes through an optical transmission line receiving a plurality of optical signals having different wavelengths;
outputting a first multi-wavelength optical signal obtained by coupling the plurality of optical signals;
dividing the first multi-wavelength optical signal into at least two multi-wavelength optical signals; and
transmitting the at least two multi-wavelength optical signals to different neighboring nodes.

12. The optical communication method of claim 11, wherein transmitting the at least two multi-wavelength optical signals to different neighboring nodes comprises:
receiving a second multi-wavelength optical signal from a first neighboring node; and
coupling the first multi-wavelength optical signal and the second multi-wavelength optical signal to transmit a coupled multi-wavelength optical signal to a second neighboring node.

13. The optical communication method of claim 12, wherein transmitting a coupled multi-wavelength optical signal to the second neighboring node comprises:
dividing the second multi-wavelength optical signal by entire signals, by channels, or by bands; and
coupling the divided second multi-wavelength optical signal to the first multi-wavelength optical signal to transmit a coupled multi-wavelength optical signal to the second neighboring node.

14. The optical communication method of claim 12, wherein transmitting a coupled multi-wavelength optical signal to the second neighboring node comprises:
receiving a third multi-wavelength optical signal from a second neighboring node; and
coupling the first multi-wavelength optical signal and the third multi-wavelength optical signal to transmit a coupled multi-wavelength optical signal to the first neighboring node.

15. The optical communication method of claim 14, wherein transmitting a coupled multi-wavelength optical signal to the first neighboring node comprises:
dividing the third multi-wavelength optical signal by entire signals, by channels, or by bands; and
coupling a divided third multi-wavelength optical signal and the first multi-wavelength optical signal to transmit a coupled multi-wavelength optical signal to the first neighboring node.

16. The optical communication method of claim 15, further comprising, after transmitting the at least two multi-wavelength optical signals to the different neighboring nodes:
receiving a plurality of multi-wavelength optical signals from a plurality of neighboring nodes;
coupling a plurality of received multi-wavelength optical signals;
dividing a plurality of coupled multi-wavelength optical signals into a plurality of multi-wavelength optical signals to output the plurality of multi-wavelength optical signals; and
dividing a plurality of divided multi-wavelength optical signals by wavelengths to output divided multi-wavelength optical signals.
